(19) United States
(12) Patent Application Publication
(10) Pub. No.: US 2011/0114784 A1
(43) Pub. Date: May 19, 2011

(54) HUMAN-POWERED, BIRD-LIKE WINGS FLYING DEVICE

(76) Inventor: Viatcheslav Abramian, Boston, MA (US)

(21) Appl. No.: 12/947,060

(22) Filed: Nov. 16, 2010

Related U.S. Application Data
(60) Provisional application No. 61/261,493, filed on Nov. 16, 2009.

(51) Int. Cl. B64C 33/02; B64C 1/00

(52) U.S. Cl. 244/13

(57) ABSTRACT

The human-powered, bird-like flying device of the present invention has wings which may rotate around the keel and legs that let the pilot control rotation of the wings, which is to make the wings flap. The present invention develops one of the more efficient methods of ascending, which is to increase the angle of attack by moving the control bar forward while shifting the pilot's weight to efficiently strike onto the legs that make the wings flap downward. The present invention is secure and stable in the air, particularly while ascending and descending. This is done by selecting the proper shape and sail area of the wings and by proper attachment of the arm, legs and the hang loop, which hold the pilot's body.

### TECHNICAL FIELD

This invention relates to flying devices, such as hang gliders, kites, paragliders, ornithopters, sailplanes, and various other flying devices. More specifically, this invention relates to a flying device, such as, but not limited to, one that is human powered, has bird like wings, and achieves ascent by flapping of the wings.

### BACKGROUND

Any discussion of the prior art throughout the specification should in no way be considered as an admission that such prior art is widely known or forms part of common general knowledge in the field.

The earliest attempt to build a flying device is described in the Ancient Greek story about Daedalus and Icarus (1500 BC). Icarus was able to glide and soar in the beginning of his flight, but we do not have any evidence that he flapped the wings. Two problems are associated with Icarus' device. First, is the construction of the wings, i.e., the joints of the components itself and their relationship to Icarus' body. When Icarus soared up for some time, the joints melted since the glue was made out of wax. The second, and most important problem, is that Icarus would not be able to flap the wings. Indeed, the proportion of the power of human hands to the body's weight is many times less than the proportion of the power of the birds' wings to their weight. Bird may flap their wings. However, humans cannot flap the artificial wings using their hand muscles. This problem has been encountered by other inventors of wings many times for the next three and half millenniums after Icarus.

The second milestone that influence our creative thinking for building the human-powered bird-like-wings is Leonardo da Vinci's flying device (circa 1485). da Vinci's flying device resembles the modern hang gliders and ornithopter, a winged-flapping device intended to fly. However, this device would be difficult to reduce into practice because of the lack of the light and durable metals for building this device. This does not even take into consideration the ability to fly and the stability of the device. A model that da Vinci built for a test flight in 1496 did not fly.

In 1948 Rogallo patented the flying device “Flexible Kite” (U.S. Pat. Nos. 4,116,406 and 4,116,407), which provides a kite which is simple to fly and graceful in flight. It is simple and economically constructed. However, such hang gliders are dependent on air updrafts to maintain them airborne. Otherwise, the device is inevitably descends to earth. These devices can glide and soar, but lack the most important element of flying, the ability to ascend by flapping the wings. Many other inventors of the prior art claim that their devices may flap, but there is no evidence that these devices are able to fly; that is to glide, to soar, and to flap the wings for ascent, as well as to be stable and secure in the air. In sum, we see the following historic problems of the prior art; there is no device that sustains stability and equilibrium in the air while flapping the wings and there is no reliable method of flapping the wings for ascension.

### SUMMARY

The human-powered, bird-like-wing flying device (a/k/a KROUNK) of the present invention overcomes the problems associated with prior art. The present invention does that by the following: KROUNK has wings which may rotate around the keel and it has legs that let the pilot control rotation of the wings, which is to make the wings flap. The present invention develops one of the more efficient methods of ascending, which is to increase the angle of attack by moving the control bar forward while shifting the pilot's weight to efficiently strike onto the legs that make the wings flap downward. The present invention is secure and stable in the air, particularly while ascending and descending. This is done by selecting the proper shape and the area of the wings and by proper attachment of the arm, legs and the hang loop, which holds the pilot's body.

It is a goal of the present invention to illustrate the following: (1) how to construct a human-powered, bird-like flying device that has two wings able to flap; (2) a method of use of this device; (3) a means of manufacturing the device, and (4) a superior method of flying which includes, but is not limited to, a superior method of ascending.

Further, it is another goal of the present invention to illustrate the methodologies that may be used in order to flap the wing for ascension in a variety of flying devices.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a front view of the present invention illustrating the components that make up the present invention.

FIG. 2 is a perspective view of the present invention.

FIG. 3 is perspective view of the keel, the arm, and the hang loop of the present invention.

FIG. 4 is perspective view of the leading edges, as well as the keel, arm, and the hang loop of the present invention when placed in use.

FIG. 5 is perspective view of a first embodiment of the present invention.

FIG. 6 is perspective view of a second embodiment of the present invention.

### DETAILED DESCRIPTION OF THE INVENTION

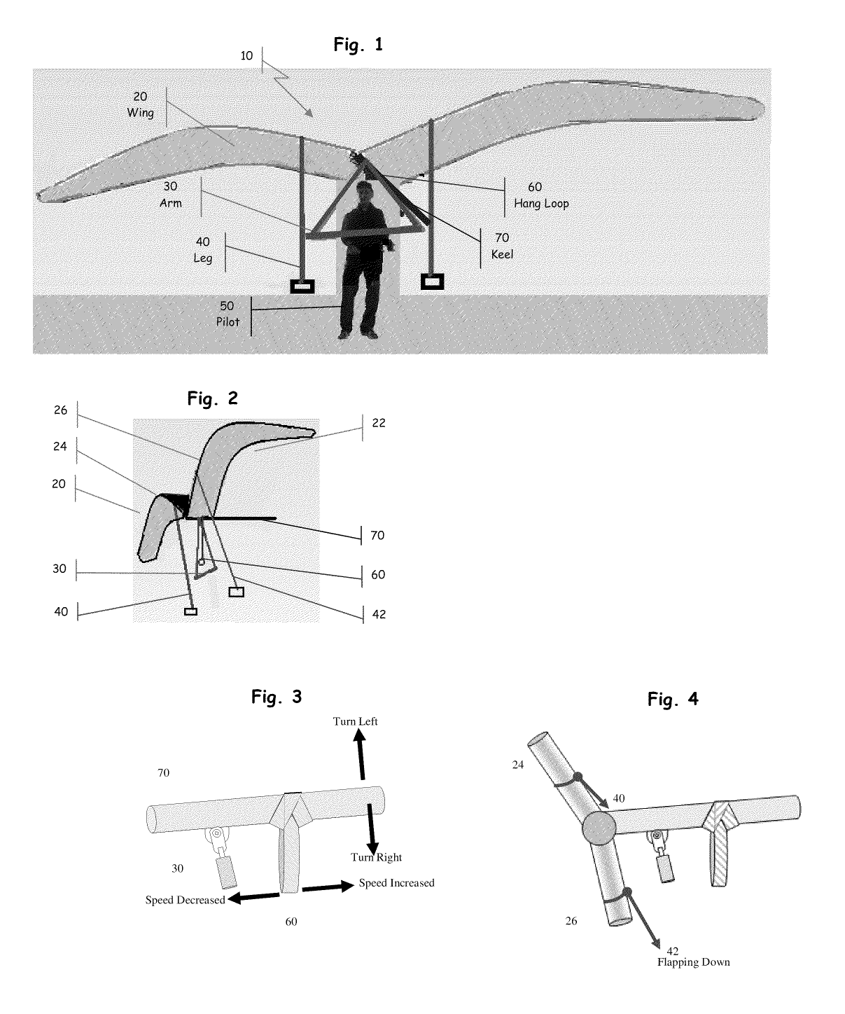

Overview: In FIG. 1, flying device 10 has wings or sails 20, 22, arm 30, legs 40, a pilot 50, a hang loop 60, and a keel 70. Both right wing 20 and left wing 22 are capable of rotating several degrees around keel 70. Legs 40 and 42 are securely attached to right wing 20 and left wing 22. Pilot 50 is hanging on keel 70 by hang loop 60. The pilot's hands may push inward and outward, left and right on arm 30 and their feet on legs 40 and 42 to push them straight down, down-left, down-right, down-inward, or down-outward.

In FIG. 2, flying device 10 has a right wing 20, which has a right leading edge (RLE) 24, which is attached to keel 70. Also, flying device 10 has left wing 22, which has a left leading edge (LLE) 26, which is attached to keel 70. Hang loop 60 and arm 30 are securely attached to keel 70.

RLE 24 and LLE 26 are metal tubes. Alternatively, they may be a rod or other similar forms. RLE 24 and LLE 26 run along the front edge of the left wing 22 and right wing 20 to keep them taut. Legs 40 and 42 may pull RLE 24 and LLE 26 down, which make RLE 24 and LLE 26 rotate to some degree around keel 70. Pilot 50 may push the legs down and the wings flap down.

FIG. 3 illustrates how hang loop 60 and arm 30 are attached to keel 70. It also illustrates that when hang loop 60 moves toward the nose of flying device 10, the speed of the device is increased. When hang loop 60 moves toward the tail, the speed of the device is decreased. When hang loop 60 moves to the right, flying device 10 moves to the right TR. When hang loop 60 moves to the left, the device 10 turns to the left TL.

The intention of these figures is to illustrate a preferred methodology of making the flying device 10 with pilot 50 moving up, left, right, increasing the speed forward, or decreasing the speed. The unique means for ascending is the use of the components of flying device 10, such as wings 20 and 22, arm 30 and legs 40 and 42. In alternative embodiments, any number of combination of wing shapes, arm, and legs and their elements may be used, all of which would be considered under the scope of the present invention.

Arm: In FIG. 2 and FIG. 3, keel 70 is a light metal tube attached longitudinally to the intersection of wings 20 and 22. Keel 70 supports RLE 24 and LLE 26 and allows RLE 24 and LLE 26 rotate to some degree around keel 70. Hang loop 60 is attached to keel 70 and suspends pilot 50. Arm 30 is attached to keel 70 near hang loop 60 and allows pilot 50 shift his or her weight to the right, left, forward, and backward. Arm 30 connects to wires (not shown) to prevent wings 20 and 22 from folding upward when in flight. Arm 30 also serves to transmit the pilot's control of wings 20 and 22 to the left, right, backward, and forward.

Legs: In FIG. 4, legs 40 and 42 are attached to RLE 24 and LLE 26 and allow pilot 50 to shift their weight from keel 70 to RLE 24 and LLE 26 and vice versa. Legs 40 and 42 also serve to transmit the pilot's control of wings 20 and 22 by moving them up or down and making them rotate to some degree around keel 70. Hang loop 60 serves to hang the pilot dynamically on the center of gravity of flying device 10.

Wings: Wings 20 and 22 form a surface that is acted upon by aerodynamic forces to keep flying device 10 aloft. They are able to respond to pilot 50 who exercises control by the shifting of the pilot's body weight from keel 70 to legs 40 and 42. Wings 20 and 22 may be moved around keel 70; thus, efficiently exercising flap and creating additional lift allowing flying device 10 with pilot 50 to move upward.

Method of Manufacture: In FIG. 2, RLE 24, LLE 26, and keel 70 are made of a light metal, wood, foam, or other durable material, including but not limited to, an aluminum alloy. The Legs 40 and 42 are made of flexible ropes, including but not limited to, stainless steel wires or synthetic nylon ropes. Left wing 20, right wing 22, and keel 70 are attached together at one end in such a way that left wing 20 and right wing 22 may rotate around keel 70. Wings 20 and 22 are made of a durable fabric, including but not limited to, nylon or polyethylene terephthalate (Dacron®). The sail area of wings 20 and 22 has to be determined according to the pilot weight. It may range, but is not limited to, from between approximately 80 sq. ft. to 250 sq. ft. Hang loop 60 is attached to keel 70 at the point where the center of applying forces (the sum of the weight of the pilot and the device) and the center of lift. Arm 30 are attached to keel 70 a slight distance behind hang loop 60 to allow pilot 50 to move arm 30 and thus may move hang loop 60 and himself to exercise the control over flying device 10. Legs 40 and 42 are attached to some part of the middle of left wing 20 and right wing 22. A variety of means may be used for attaching above mentioned components, including but not limited to above mentioned means.

Method of Use: Pilot 50 exercises control by shifting body weight in opposition to arm 30. That is, wings 20 and 22 are controlled by changing their pitch and roll by means of shifting their center of applied forces. This is done by suspending the payload in the center by applying weights beneath wings 20 and 22 and moving pilot 50 left or right or forward or aft. When the center of applied weight of the pilot's body shifts toward the nose, the angle of attack of flying device 10 is decreased and, consequently, the speed of the device 10 is increased. When the body weight of pilot 50 shifts toward the tail, the angle of attack of flying device 10 is increased, and consequently, the speed of device 10 is decreased. When the body weight of pilot 50 shifts left, device 10 turns left. When the pilot's body shifts right, device 10 turns right. When the pilot's body weight shifts from hang loop 60 to legs 40 and 42, wings 20 and 22 are rotated down around keel 70. When pilot 50 releases the body weight pressure from legs 40 and 42 back to hang loop 60, wings 20 and 22 are rotated up around keel 70. When the pilot 50 pushes legs 40 and 42 straight-down, down-left, down-right, down-inward, or down-outward, the angle of attack or roll changes, and the direction of flight is changed accordingly.

Method of Flying [locomotion]: There are several aerial locomotion maneuvers, including but not limited to, gliding flight, soaring, and flying proper. Gliding flight is defined as falling at less than 45 degrees from the horizon. Soaring is essentially a form of gliding wherein the device is rising or otherwise moving air without flapping the wings. When pilot 50 hangs on hang loop 60 and does not shift their weight onto legs 40 and 42, wings 20 and 22 are not rotating around the keel 70; that is, they do not flap and flying device 10 is gliding or soaring. However, flying proper is defined as the flapping of wings to produce thrust ascending without the aid of the motion of the wind itself, as opposed to gliding and soaring. When wings 20 and 22 flap, as opposed to gliding or soaring, they develop some lift as before due to the shape of wings 20 and 22 that produce aerodynamic force which lifts flying device 10. Wings 20 and 22 change the angle of attack between the up-stroke and the down-stroke. When pilot 50 shifts their weight at a certain speed from hang loop 60 to legs 40 and 42; that is, making the wings 20 and 22 down-stroke, pilot 50 also moves arm 30 forward, increasing the angle of attack, or pushing legs 40 and 42 down and forward without pushing arm 30. This combination of moves makes flying device 10 move upward and forward.

### ALTERNATIVE EMBODIMENTS

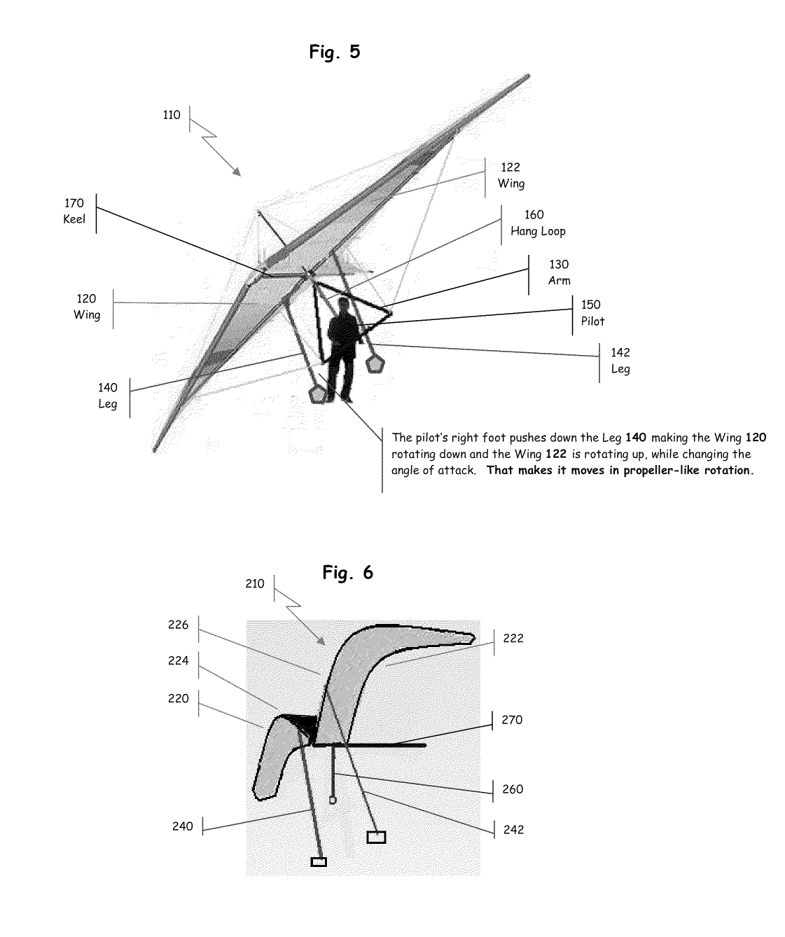

In FIG. 5, flying device 110 works in much the same manner as flying device 10 in FIG. 1. Flying device 110 has wings 120 and 122, arm 130, legs 140 and 142, pilot 150, hang loop 160, and keel 170. Both the right wing 120 and left wing 122 may either rotate to some degree around keel 170, or may be fixed together without the ability to rotate around keel 170. Legs 140 and 142 are securely attached to right wing 120 and left wing 122. Pilot 150 hangs on keel 170 by hang loop 160. The hands of pilot 150 may push arm 130 inward and outward, left and right, and their feet may be positioned on legs 140 and 142 to push them down.

Method of Flying [locomotion] of the First Embodiment: There is an important difference in locomotion when right wing 120, left wing 122 and keel 170 are fixed together. When pilot 150 pushes down on leg 140, right wing 120 flaps down, and left wing 122 flaps up. When pilot 150 pushes down on leg 142, left wing 122 flaps down, and right wing 120 flaps up. While pushing legs 140 or 142 up and/or down, pilot 150 pushes and/or pulls arm 130; thus changing the angle of attack. The entire flying device is rotating around an imaginary axis in propeller-like rotation.

In FIG. 6, flying device 210 works in much the same manner as flying device 10 in FIG. 2. However, flying device 210 does not have arm. However, the angle of attack and rolling may be controlled by pushing legs 240 and 242 down-forward, or down-backward, or down-left, or down-right. The performance of this variant of the flying device 210 is substantially the same: even though it does not have arm.

The spirit of the present invention provides a breadth of scope that includes all methods of the human-powered bird-like flying device, element of another flying device. The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A flying device comprising:
a keel;
a pair of wings, the pair of wings being attached to the keel, wherein the pair of wings further comprises a left wing and a right wing, wherein the left wing further comprises a left leading edge and the right wing further comprises a right leading edge;
a hang loop, the hang loop being attached to the keel; and
a pair of legs, wherein the pair of legs further comprises a left leg and a right leg, wherein the left leg is attached to the left leading edge of the left wing and the right leg is attached to the right leading edge of the right wing.

2. The flying device of claim 1 wherein the keel is longitudinally positioned at an intersection of the left wing and the right wing.

3. The flying device of claim 1 wherein the left wing and the right wing are rotatable around the keel.

4. The flying device of claim 1 wherein the left leading edge and the right leading edge are attached to the keel.

5. The flying device of claim 1 wherein the keel, the left leading edge, and the right leading edge are tubular members.

6. The flying device of claim 1 wherein the keel, the left leading edge, and the right leading edge are made of a material selected from the group consisting of: metal, wood, foam, and a combination thereof.

7. The flying device of claim 6 wherein the keel, the left leading edge, and the right leading edge are made of an aluminum alloy covered by foam.

8. The flying device of claim 1 wherein the left leading edge and the right leading edge are made taut by pulling down on the left leg and the right leg and cause the left leading edge and the right leading edge to rotate around the keel.

9. The flying device of claim 1 wherein movement of the hang loop toward a nose portion of the flying device increases velocity of the flying device, wherein movement of the hang loop toward a tail portion of the flying device decreases velocity of the flying device, wherein movement of the hang loop in a rightward direction moves the flying device in the rightward direction, and wherein movement of the hang loop in a leftward direction moves the flying device in the leftward direction.

10. The flying device of claim 1 wherein the legs are made of a material selected from the group consisting of: stainless steel wires, synthetic nylon ropes, and a combination thereof.

11. The flying device of claim 1, wherein the wings are made of a material selected from the group consisting of: nylon, polyethylene terephthalate, and a combination thereof.

12. The flying device of claim 1 wherein a sail area of the pair of wings ranges between approximately 80 square feet to 250 square feet.

13. The flying device of claim 1 wherein a shift in a body weight of a user from the hang loop to the pair of legs causes rotation of the pair of wings down around the keel and wherein the shift in the body weight of the user from the pair of legs to the hang loop causes rotation of the pair of wings up around the keel.

14. The flying device of claim 13 wherein a stasis in the body weight of the user between the hang loop and the pair of legs causes the pair of wings to remain static in relation to the keel and the flying device to glide.

15. The flying device of claim 1 wherein the left wing, the right wing, and the keel are fixed together, wherein pressure on the right leg causes the right wing to flap down and the left wing to flap up, wherein pressure on the left leg causes the left wing to flap down and the right wing to flap up, and wherein pressure is exerted on the arm in conjunction with the pressure on the right leg and the left leg causing the flying device to rotate in a circular motion.

16. The flying device of claim 1 wherein the pair of wings is flexibly attached to the keel by a hinge and a plurality of ropes.

17. The flying device of claim 1 wherein the hang loop is attached to the keel at a point near a center of applied forces and a center of lift.

18. The flying device of claim 1 further comprising an arm, the arm being attached to the keel, wherein the arm is positioned in front of the hang loop.
